(19) United States
(12) Patent Application Publication
(10) Pub. No.: US 2023/0379322 A1
(43) Pub. Date: Nov. 23, 2023

(54) IDENTITY VERIFICATION METHOD AND SYSTEM

(71) Applicant: Robert Taaffe Lindsay, San Francisco, CA (US)

(72) Inventor: Robert Taaffe Lindsay, San Francisco, CA (US)

(73) Assignee: Campaign Verify INC, Washington, DC (US)

(21) Appl. No.: 17/747,294

(22) Filed: May 18, 2022

(51) Int. Cl. H04L 9/40; G06Q 50/26

(52) U.S. Cl. CPC H04L 63/0853; G06Q 50/265; H04L 63/083; G06Q 2230/00

(57) ABSTRACT

The present invention provides a verification system and method for political campaigns to use A2P 10 DLC text messaging in a way to minimize opportunities for spoofing or spamming campaign messaging. A token is generated once entered data is compared and verified, particularly a URL associated with a particular campaign. A PIN is generated after the initial comparison confirms that the entered data is valid, and once the PIN is returned to the verification platform, the token is delivered to the particular campaign. The token is then delivered to the campaign's campaign service provider (CSP), which can then use the token to register the campaign's 10 DLC text messaging program with carriers or a registration authority, or other aggregators. The token represents a verification indication that the CSP or other entity is a valid representative of a valid political campaign.

### BACKGROUND OF THE INVENTION

### 1. Field of the Invention

The present invention relates to systems and methods for avoiding improper spoofing of individuals, entities and/or organizations engaged in messaging across digital and telecommunication networks. In verifying political campaigns, identity verification is achieved by generating secure authorization tokens which are used to ensure that messaging originates from the party authorized to send it, and the receiver has assurance that the message is not the result of spoofing or other communications scamming efforts.

### 2. Description of the Related Art

Studies show that up to 98% of adults today in the United States have mobile “smart” phones capable of sending and receiving short message service (SMS) text messages. By 2023, projected use of mobile phones worldwide will reach over 8 billion. Significantly, consumers have developed a preference for communicating by text message, over emails and voice calls/messages. Statistics show that up to 95% of text messages are read and responded to within 3 minutes of receipt.

The use of text messaging for marketing purposes has taken off in recent years. Text message marketing is in line with today's social trends which lean toward fast-paced, if not instant, communication of thoughts, ideas, opinions, and needs. Businesses need to keep up with those trends in order stay relevant, successful, and viable. One of the best ways to do so is to advertise using text messaging, which are viewed by consumers to be more focused and personal. The consumer can immediately understand the short message which comes to the consumer's personal communicator, i.e., the cellular phone. Without exaggeration, the cell phone has become indispensable to every adult who owns one. It stores contacts, content, applications for every phase of life, from personal navigation, e.g., Google Maps, to social media platforms like Facebook, Twitter, TikTok, to name a few. Today, no one is far from their phone, and this fact alone justifies why an advertiser would want, and need, to send text messages.

Text message advertising provides a unique opportunity in the world of political campaigning, where “getting the message out” is as important as anything. Traditional campaign messaging, prior to the proliferation of modern telephony, involved mostly print media (newspaper and magazine advertisements, brochures, flyers, etc.), radio, television, and more recently, streaming media. While there may never be a substitute for radio and television and video/audio streaming, print media suffers from several shortcomings.

An opportunity exists for text messaging to take the words of print media, and literally put them in the pockets of every potential targeted voter. A carefully drafted statement, succinctly put into a text message, can be “delivered” accurately, inexpensively, and effectively, so that the intended recipient instantly gets the message. In political campaigning, getting the message to the voter is critical, and text messaging can provide the preferred means to do so.

The rising use of text messaging has also generated a rise in misuse schemes, defined by such terms as spamming, spoofing, and phishing. Both the Federal Communication Commission (FCC) and the Federal Trade Commission (FTC) have responsibility for protecting consumers from illegal or inappropriate use of the communications networks. For example, spoofing is when a caller deliberately falsifies the information transmitted to the consumer's caller ID display to disguise their identity. Scammers often use neighbor spoofing so it appears that an incoming call is coming from a local number, or spoof a number from a company or a government agency that the consumer may already know and trust. In one example of inappropriate use, if the consumer answers, the scammer can use scam scripts to try to steal money or valuable personal information, which can be used in fraudulent activity.

Similarly, in political campaigns, a scammer could create the appearance of being a legitimate campaign message sender, only to send a misleading, false or misinformative message in order to shed a negative light on the campaign. Particularly in the field of campaign messaging, a need exists to verify the identity of the sender of a message, so that the receiver of the message has assurances that the message is true, accurately reflects the message intended by the campaign to be sent, and is delivered by an entity who is who they say they are.

### SUMMARY OF THE INVENTION

The present invention provides improved verification for campaigns, to avoid unauthorized transmission of text messaging. The invention is particularly suitable for A2P 10 DLC messaging. “A2P” refers to “application-to-person” and “10DLC” refers to “10-digit long code” phone numbers. This is the newest service for business text messaging using SMS. Wireless carrier's A2P 10DLC offerings provide better delivery quality and lower filtering risk than long code SMS of the past, using the same phone numbers. For political campaigns, 10DLC provides the same advantages as pure business-to-consumer texting, by making more trusted messaging and better deliverability. A2P 10DLC requires a political registration process that quickly identifies spam, spoof or other unwanted traffic.

In preferred embodiments, a political campaign registers with an election authority. For federal elections, the campaign authority is the Federal Election Commission (“FEC”). For state, local and tribal campaigns, the election authority may be the Secretary of State's website or the county or municipal government's website. Once registered with the relevant election authority, the campaign receives a URL as part of its filing record. The filing record will also include a postal mail address and/or email. To obtain verification, the campaign visits the website of a verification platform, which provides a user interface for soliciting, and giving, information pertinent to verification. In another embodiment, the campaign submits their information to a third-party campaign service provider (CSP), who submits the verification request with that information to the verification platform on behalf of the campaign. In such an embodiment, the campaign would submit their PIN code either to their CSP for submission to the verification platform, or directly to the verification platform itself. In another embodiment, the campaign submits the information to the registration authority. In such an embodiment, the registration authority would submit the verification request to the verification platform who would deliver the PIN code directly to the campaign. The campaign would in turn submit the PIN code to the verification platform directly.

The campaign, having access to its published filing record, accesses the verification platform and provides its campaign URL and a preferred delivery mechanism. The verification platform may also solicit additional information which may include the election date, location, names of contact personnel, and other pertinent information. The information is submitted by the campaign, and then processed by the verification platform. Processing includes verifying that the URL on record with the election authority is the same as the URL submitted by the campaign, as well as verifying that submitted contact information matches contact information on file with the election authority.

Once the verification platform confirms the accuracy and validity of the submitted information, a PIN is sent to the campaign at the email address or postal mail address submitted with the campaign's verification platform submission. The campaign then logs back onto the verification platform, and supplies the PIN. Once the PIN is received and validated, the campaign is able to generate an authorization token. The token is then provided by the campaign to its campaign service provider (“CSP”), which is a company with a messaging platform that creates and manages text messaging campaigns for their customers. The CSP submits the token to a registration authority to show proof of identity verification. U.S. wireless carriers in return receive metadata confirming the political campaign's identity.

In a preferred method, a verification process includes obtaining filing information data from an election authority registration document from a particular campaign, the filing information including at least a URL associated with the particular campaign and a point of contact, comparing entered data to data available from public records to verify the validity of the entered data, sending a PIN to the particular campaign when the entered data matches the public data, receiving the PIN from the particular campaign, and if the PIN is entered correctly, generating an authorization token, and delivering the token, on request, to at least one of the point of contact for the campaign and a texting vendor, whereby the token is capable of use by the particular campaign to gain required registration for political text messaging with a carrier.

### BRIEF DESCRIPTION OF THE DRAWINGS

FIG. 1 is a flow chart showing the methodology of the present invention; and;

FIG. 2 is a schematic view showing the system of the present invention.

### DETAILED DESCRIPTION OF THE INVENTION

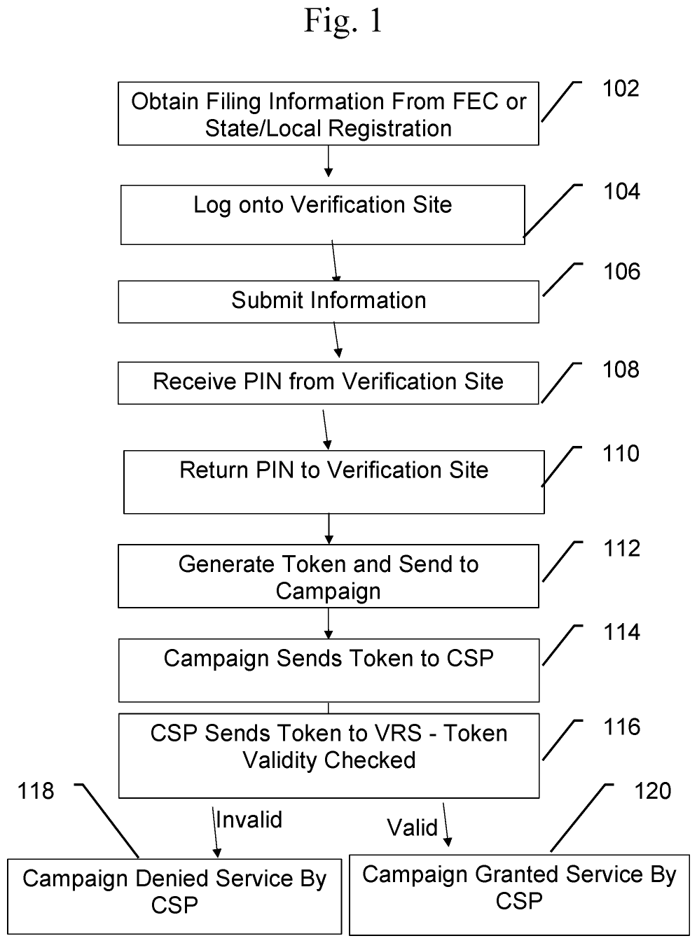

Referring to FIG. 1, a campaign, which could be referred to as the “brand,” or an individual candidate, PAC, or other campaign entity, must have a campaign filing record through the FEC or other appropriate state, local or tribal election authority. The verification process 100 comprises a series of steps, preferably implemented on a verification platform based on a website and a series of user interfaces that permit the submission of information and the sending of authorizations. Prior to the first step, a campaign has been registered with an election authority, such as the FEC or Secretary of State of a particular state. In step 102, the campaign obtains its filing information from its FEC, state, local or tribal election authority registration. This information includes a URL assigned to the campaign by the election authority and further includes contact information, such as a physical address or an email address.

Once this information is at hand, at step 104 the campaign logs onto a verification site through a communication network, such as the internet. The verification site is a platform for a campaign and a verification body to interact. At step 104, the campaign is prompted to enter information about the campaign, including the URL and contact information, preferably both a physical address and an email address. At step 106, the prompted information is submitted to the verification site so that the information can be checked for accuracy and coincidence between the campaign and its published filing record. At a minimum, the verification site confirms that the URL on record with the election authority is the same as the URL submitted by the campaign. Fact checking can be performed manually by workers at the verification body, or by programmed software interacting with databases. While verification is taking place, the campaign official who was entering data at the verification site will typically logsoff.

Once the information is confirmed, at step 108 the verification site sends a PIN to the campaign. The PIN is sent to an address identified by the campaign as part of their submission. Typically, the PIN is sent to an email associated with the campaign, although a campaign could also select a preference to communicate by regular mail. In that case, the PIN would be mailed to the campaign through regular mail.

Once the campaign receives the PIN, at step 110 the campaign returns the PIN to the verification platform by entering it into the campaign's application for verification. If the PIN is entered correctly, the campaign will generate an authorization token on the verification platform at step 112, which can be sent to the campaign upon request. Once in possession of the token, the campaign preferably delivers the token to its CSP at step 114, to be used as proof that the campaign is verified. In one embodiment, the CSP can use the token to verify that its text messaging program is for a legitimate campaign, particularly for a registration authority.

At step 116, the CSP sends the token to a verification and registration service (VRS). One such VRS is The Campaign Registry (https://thecampaignregistry.com). The VRS registers the campaign's 10 DLC text messaging campaign with a mobile network operator (MNO), which is the wireless carrier who provides connectivity to end user's mobile carrier. Optionally, the CSP works through an intermediating Direct Connect Aggregator (DCAs) who provides direct connectivity to the mobile carrier's gateway for delivering messaging campaigns. In that case, the token goes from the campaign, to the CSP, to the DCA, and then to the VRS. Registration is a requirement of 10DLC text messaging. The registration authority assists in registering users of A2P 10DLC text messaging with carriers who implement A2P 10DLC.

The CSP preferably has an account with its preferred VRS. To gain registration on behalf of the campaign, the CSP logs into its account at the VRS, enters the name of the campaign and other information, including the token. The VRS confirms that the token is valid or invalid, by comparing the entered token to the campaign's token, which was given to the VRS by the verification site, through an API or manual entry. Depending on whether the token is valid or invalid, the CSP is denied service to the campaign at step 118 or allowed service to the campaign at step 120.

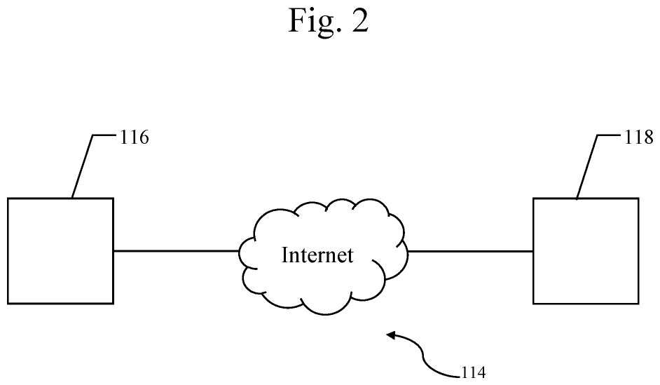

Referring to FIG. 2, a system 122 for verifying campaigns includes a server 124 which is capable of serving web pages, reflecting user interface between the verification platform or site, and a particular campaign, brand, candidate or similar entity. The campaign, using a client device 128, can submit information to the server 124, and the server can return information to the client device. The client device and server communicate through any suitable communications network, including the internet. Once the client device 128 receives a token, the campaign can forward the token through any suitable means to a CSP for use to verify the campaign. The client device 128 can be a computer having a display for displaying web pages that provide access to the server 124. Verification can be done automatically if the server includes the ability to automatically review databases, match data from the databases to data input by the campaign, and send PINs and tokens, in response to entered data and compared data.

Verification can be based on information other than a URL. The preferred information for comparison will likely depend on the particular type of election (state vs. local) and on the ease of access to data.

The format of the token has a preferred six pipe (|) delimited fields, for the example cv|1.0|tcr|10dlc|9957c339-d46f-49b7-a399-2e6d5ebac66d| GQ3NMEjED8xSlaAgRXAXXBUNBT2AgL-LdQuPveFhEyy, where pipe (1) is a cv prefix, corresponding to a particular verification platform, pipe (2) is the token version, so for a particular verification platform, the beginning version would be 1.0, pipe (3) is the service ID, corresponding in the preferred embodiment to the registration authority pipe (4), pipe (5) is the channel ID, corresponding to the texting format, which in the preferred embodiment is 10DLC, which appears in the token as “10dlc,” and pipe (6) is a secret 32 bit URL safe random string.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A verification process comprising:
obtaining filing information data from an election authority registration document from a particular campaign, the filing information including at least a URL associated with the particular campaign and a point of contact;
comparing entered data to data available from public records to verify the validity of the entered data;
sending a PIN to the particular campaign when the entered data matches the public data;
receiving the PIN from the particular campaign, and if the PIN is entered correctly;
generating an authorization token; and
delivering the token, on request, to at least one of the point of contact for the campaign and a texting vendor, whereby the token is capable of use by the particular campaign to gain required registration for political text messaging with a carrier.

2. The verification process of claim 1, wherein the entered data includes an email address, a physical address, and an indication of a preference for either address to be the destination for data sent from the website.

3. The verification process of claim 1, wherein the election authority is one of a federal, state, local and tribal election authority.

4. The verification process of claim 3, wherein the election authority is the Federal Election Commission (FEC).

5. The verification process of claim 1, wherein the token has six pipe delimited fields including (1) a CV prefix, which is always “cv,” (2) a token version, beginning with 1.0, (3) a service ID, corresponding to the registration authority (4) a channel ID corresponding to 10dlc, (5) a committee ID corresponding to UUID, and (6) a secret 32 bit URL safe random string.

6. A verification system comprising:
a server hosting a verification application;
a client device corresponding to each campaign seeking verification through the verification system;
the server and the client being capable of communication with each other through a communications network;
the verification application including means for accepting data from a particular campaign, the data including at least a URL from an election authority registration associated with the particular campaign and a point of contact;
the client device including means for sending data to the verification application, means for receiving from the server a PIN when entered data is verified to be valid, and means for returning the PIN to the server; and
the application platform including means for generating and sending on request, from at least one of a point of contact for the particular campaign and a texting vendor, a token to the particular campaign once the PIN is returned to the server.

7. A verification system according to claim 6, wherein the election authority is one of a federal, state, local and tribal election authority.

8. A verification system according to claim 7, wherein the election authority is the Federal Election Commission (FEC).
